(19) United States
(12) Patent Application Publication
(10) Pub. No.: US 2024/0126955 A1
(43) Pub. Date: Apr. 18, 2024

(54) Physics-Informed Machine Learning Model-Based Corrector for Deformation-Based Fluid Control

(71) Applicants: Disney Enterprises, Inc., Burbank, CA (US); ETH Zürich (EIDGENÖSISCHE TECHNISCHE HOCHSCHULE ZÜRICH), Zurich (CH)

(72) Inventors: Vinicius Da Costa De Azevedo, Zurich (CH); Byungsoo Kim, Zurich (CH); Barbara Solenthaler, Zurich (CH); Jingwei Tang, Zurich (CH)

(21) Appl. No.: 18/237,831

(22) Filed: Aug. 24, 2023

Related U.S. Application Data
(60) Provisional application No. 63/411,895, filed on Sep. 30, 2022.

(51) Int. Cl. G06F 30/28; G06N 20/00

(52) U.S. Cl. CPC G06F 30/28; G06N 20/00

(57) ABSTRACT

A system includes a hardware processor, a machine learning (ML) model-based corrector trained to predict a deformation of a velocity field, and a system memory storing software code. The hardware processor is configured to execute the software code to receive a deformation template and a deformed velocity field produced based on the deformation template, predict, using the ML model-based corrector based on the deformation template and the deformed velocity field, a correction to the deformed velocity field, and correct the deformed velocity field, using the correction, to provide a corrected velocity field. In some implementations, the hardware processor is further configured to execute the software code to advect the corrected velocity field to provide a density field of a corrected simulation of a deformation of a fluid or a viscoelastic material, and produce, using the density field, the corrected simulation.

### RELATED APPLICATIONS

The present application claims the benefit of and priority to a pending U.S. Provisional Patent Application Ser. No. 63/411,895 filed on Sep. 30, 2022, and titled “Physics-Informed Neural Corrector for Deformation-based Fluid Control,” which is hereby incorporated fully by reference into the present application.

### BACKGROUND

Controlling fluid simulations is notoriously difficult due to its computational cost, as well as the fact that user control inputs can cause unphysical motion. Conventionally, artists have relied on force-based fluid control techniques that use artificial force fields that can be computed by optimization or through heuristics. Optimization methods match specific objectives at an undesirably high computational cost, while heuristics provide a solution that typically does not satisfy target keyframes. Both conventional approaches define objectives by computing differences between a simulated density field and a target density field at a given frame. When simulated and objective density fields do not overlap, e.g., if the target field undergoes extreme deformations, these methods cannot provide meaningful gradients for the optimization or heuristics computation, and artificially computed force fields will not be able to properly guide simulated deformations.

Alternatively, fluids can be controlled by direct manipulation of pre-simulated fluid data. For instance, volumetric flow data can be deformed with the underlying deformation grid, and various fluid scenes may be stitched or sculpted for resizing. While these techniques offer some level of post-processing functionality, they rely on computationally expensive optimizations or re-simulations. Thus, there is a need in the art for a faster and more computationally efficient solution for accurately simulating distortions of fluids and other viscoelastic materials.

### BRIEF DESCRIPTION OF THE DRAWINGS

FIG. 1 shows an exemplary system including a physics-informed machine learning (ML) model-based corrector providing deformation-based fluid control, according to one implementation;

FIG. 2 shows a diagram of an exemplary post-processing pipeline including a physics-informed ML model-based corrector providing deformation-based fluid control, according to one implementation;

FIG. 3 describes an exemplary neural network architecture suitable for use as a ML model-based corrector for deformation-based fluid control, according to one implementation;

FIG. 4 compares fluid simulations produced using the present solution with two existing state-of-the-art approaches for different exemplary deformations;

FIG. 5 presents a flowchart outlining an exemplary method for use by a system including a physics-informed ML model-based corrector, for providing deformation-based fluid control, according to one implementation; and

FIG. 6 shows a table comparing fluid simulations produced using the present solution with two existing state-of-the-art approaches for different exemplary fluidic shapes, according to various implementations.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, controlling fluid simulations is notoriously difficult due to its computational cost, as well as the fact that user control inputs can cause unphysical motion. The present application presents a solution for providing deformation-based fluid control using a physics-informed machine learning (ML) model-based corrector. The present solution seeks to balance the advantages of direct manipulation of fluids with the constraints imposed by their intrinsic physical characteristics. ML models, such as those implemented as neural networks (NNs) for example, may be trained with physics-informed loss functions together with a differentiable fluid simulator, thereby providing an efficient workflow for flow manipulations at test time. The results of application of the present solution to diverse test cases demonstrate that the particularly designed objectives disclosed herein lead to physical and eventually visually appealing modifications on edited fluid data.

To enable efficient artistic control that can work with a wide range of deformation types, the exemplary approach disclosed herein post-processes fluid data, but with a key difference of enabling target matching in interactive environments while preserving physical constraints. In the pipeline, a base fluid configuration may be simulated and deformed with accessible control tools for prototyping. The trained ML model-based corrector corrects the motion to increase physical realism. This may be enabled by a self-supervised neural corrector that projects the deformed simulations back onto the manifold of the governing equation or equations for the fluid or other material undergoing deformations, such as, for example, the Navier-Stokes equations in the case of incompressible fluids.

It is noted that although the present novel and inventive concepts are described below in detail by reference to deformation of fluids, those concepts may be readily adapted for application to a variety of viscoelastic materials. As defined in the present application, the term “fluid” has its commonly accepted meaning in the field of physics and refers to a liquid, gas, or other material that continuously deforms under an applied sheer stress, or external force. It is further noted that the expression “viscoelastic material” refers to a material that has both elasticity and viscosity.

It is also noted that the present solution for providing deformation-based fluid control can advantageously be implemented as automated systems and methods. As defined in the present application, the terms “automation,” “automated,” and “automating” refer to systems and processes that do not require the participation of a human system operator. Thus, the methods described in the present application may be performed under the control of hardware processing components of the disclosed automated systems.

The present deformation-based fluid control solution implements a trained ML model-based corrector, which, once trained, is very efficient, and can provide corrected deformations one or more orders of magnitude faster than can be achieved using a conventional approaches. Moreover, the complexity involved in controlling the fluid deformations disclosed in the present application in a timely manner requires such trained ML models because human performance of the present solution in practical timeframes is impossible, even with the assistance of the processing and memory resources of a general purpose computer.

As defined in the present application, the expression “ML model” may refer to a mathematical model for making future predictions based on patterns learned from samples of data or “training data.” For example, ML models may be trained to perform image processing, natural language understanding (NLU), and other inferential data processing tasks. Various learning algorithms can be used to map correlations between input data and output data. Such a ML model may include one or more logistic regression models, Bayesian models, or NNs. A “deep neural network,” in the context of deep learning, may refer to a NN that utilizes multiple hidden layers between input and output layers, which may allow for learning based on features not explicitly defined in raw data.

Examples of the types of content to which the present solution for providing deformation-based fluid control may be applied include simulations of volumetric objects, as well as fluid phenomena in general, such as smoke for example. That content may be depicted by a sequence of images, such as video. In addition, that content may be depicted as one or more simulations present in a real-world, virtual reality (VR), augmented reality (AR), or mixed reality (MR) environment. Moreover, that content may be depicted as present in virtual worlds that can be experienced by any number of users synchronously and persistently, while providing continuity of data such as personal identity, user history, entitlements, possessions, payments, and the like. It is noted that the solution for providing deformation-based fluid control disclosed by the present application may also be applied to content that is depicted by a hybrid of traditional audio-video and fully immersive VR/AR/MR experiences, such as interactive video.

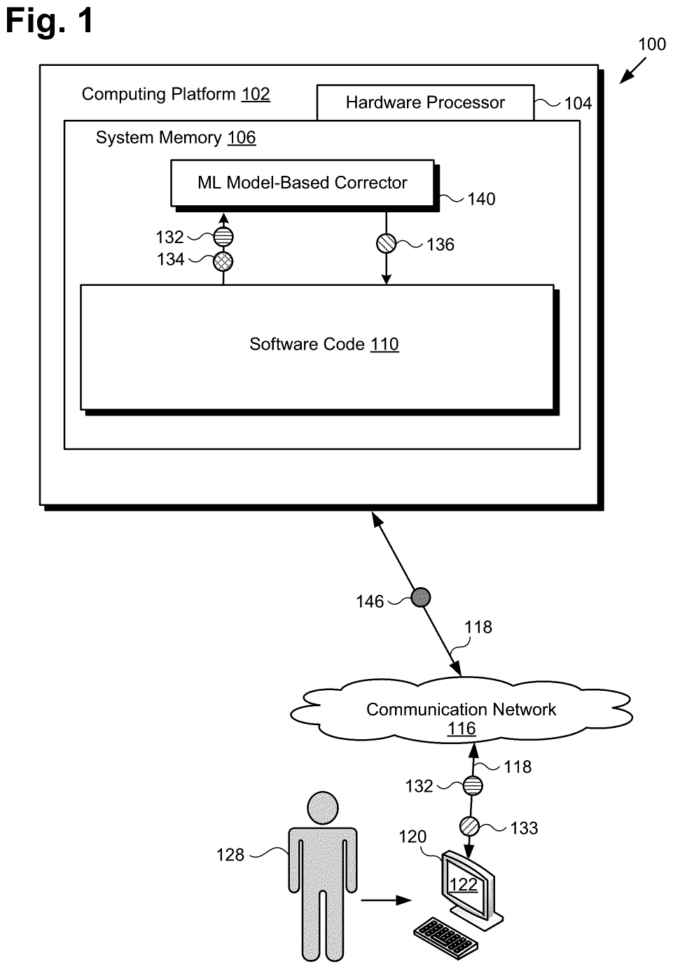

FIG. 1 shows exemplary system 100 including physics-informed ML model-based corrector 140 (hereinafter “ML model-based corrector 140”) providing deformation-based fluid control, according to one implementation. As shown in FIG. 1, system 100 includes computing platform 102 having hardware processor 104 and system memory 106 implemented as a computer-readable non-transitory storage medium. According to the present exemplary implementation, system memory 106 stores software code 110 and ML model-based corrector 140 trained to predict a deformation of a velocity field. In some implementations, ML model-based corrector 140 may include one or more NNs. Further, ML model-based corrector 140 may reside outside of system memory 106 and be accessible via a local area or wide area network.

As further shown in FIG. 1, system 100 is implemented within a use environment including communication network 116, client system 120 including display 122, and user 128 of system 100 and client system 120, who may be an artist, animator, or editor for example. In addition, FIG. 1 shows deformation template 132, which may be or include a deformation grid for example, sequence of images 133 each including a respective deformed velocity field 134 derived from a simulated deformation of a fluid or a viscoelastic material based on deformation template 132, velocity field correction 136 predicted by ML model-based corrector 140, and simulation 146 of the deformation of the fluid or the viscoelastic material after correction of deformed velocity field 134 using velocity field correction 136 (hereinafter “corrected simulation 146”). Also shown in FIG. 1 are network communication links 118 of communication network 116 interactively connecting system 100 and client system 120.

Although the present application refers to software code 110 and ML model-based corrector 140 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs such as DVDs, RAM, programmable read-only memory (PROM), erasable PROM (EPROM), and FLASH memory.

Moreover, although FIG. 1 depicts software code 110 and ML model-based corrector 140 as being co-located in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system for instance. As a result, hardware processor 104 and system memory 106 may correspond to distributed processor and memory resources within system 100. Consequently, in some implementations, software code 110 and ML model-based corrector 140 may be stored remotely from one another on the distributed memory resources of system 100. It is also noted that, in some implementations ML model-based corrector 140 may take the form of a software module included in software code 110.

Furthermore, in some implementations, system 100 may utilize a decentralized secure digital ledger in addition to, or in place of, system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for AI processes such as machine learning.

In some implementations, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth, for instance. Furthermore, in some implementations, system 100 may be implemented virtually, such as in a data center. For example, in some implementations, system 100 may be implemented in software, or as virtual machines. Moreover, in some implementations, communication network 116 may be a high-speed network suitable for high performance computing (HPC), for example a 10 GigE network or an Infiniband network.

It is further noted that, although client system 120 is shown as a desktop computer in FIG. 1, that representation is provided merely by way of example. In other implementations, client system 120 may take the form of any suitable mobile or stationary computing device or system that implement data processing capabilities sufficient to provide a user interface, support connections to communication network 116, and implement the functionality ascribed to client system 120 herein. That is to say, in other implementations, client system 120 may take the form of a laptop computer, tablet computer, or smartphone, to name a few examples. In still other implementations, client system 120 may be a peripheral device of system 100 in the form of a dumb terminal. In those implementations, client system 120 may be controlled by hardware processor 104 of computing platform 102.

It is also noted that display 122 of client system 120 may take the form of a liquid crystal display (LCD), a light-emitting diode (LED) display, an organic light-emitting diode (OLED) display, a quantum dot (QD) display, or any other suitable display screen that perform a physical transformation of signals to light. Furthermore, display 122 may be physically integrated with client system 120 or may be communicatively coupled to but physically separate from client system 120. For example, where client system 120 is implemented as a smartphone, laptop computer, or tablet computer, display 122 will typically be integrated with client system 120. By contrast, where client system 120 is implemented as a desktop computer, display 122 may take the form of a monitor separate from client system 120 in the form of a computer tower.

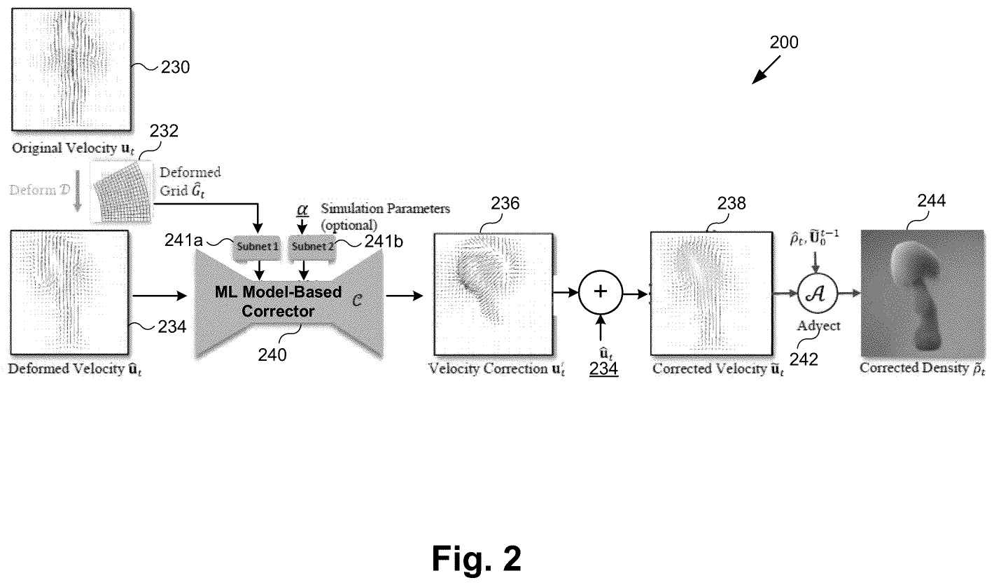

FIG. 2 shows a diagram of exemplary post-processing pipeline 200 including physics-informed ML model-based corrector 240, denoted in FIG. 2 by C, providing deformation-based fluid control, according to one implementation. Also shown in FIG. 2 are original velocity field 230 (i.e., a pre-deformed velocity field) denoted as uₜ, deformation template 232 identified as “deformed grid” and denoted as Ĝₜ, deformed velocity field 234 denoted as ûₜ, exemplary subnet 241a of ML model-based corrector 240 denoted as subnet 1, exemplary subnet 241b of ML model-based corrector 240 denoted as subnet 2, velocity field correction 236 predicted by ML model-based corrector 240 and denoted as u′ₜ, corrected velocity field 238 denoted as ûₜ, and density field 244 produced by advection 242 of corrected velocity field 238 and denoted as \hat{ρ}ₜ.

It is noted that deformation template 232, deformed velocity field 234, ML model-based corrector 240 including subnets 241a and 241b, and velocity field correction 236 correspond respectively in general to deformation template 132, deformed velocity field 134, ML model-based corrector 140, and velocity field correction 136, in FIG. 1. Consequently, deformation template 132, deformed velocity field 134, ML model-based corrector 140, and velocity field correction 136 may share any of the characteristics attributed to respective deformation template 232, deformed velocity field 234, ML model-based corrector 240, and velocity field correction 236 by the present disclosure, and vice versa.

Referring to FIGS. 1 and 2 in combination, according to post-processing pipeline 200, deformation template 132/232 and sequence of images 133 each including a respective deformed velocity field 134/234 depicting a fluid or viscoelastic material is received by system 100 from client system 120 utilized by user 128. It is noted that, as defined in the present application, the feature recited as a “deformation template” or a “deformation grid” refers to a field that defines how a three-dimensional (hereinafter “3D”) space is deformed. In practice, the deformation template or grid is provided by the user to control how the fluid simulation should change spatially.

It is further noted that although FIG. 1 depicts sequence of images 133 being received from client system 120, that representation is merely provided as an example. In other implementations, sequence of images 133 may be received or obtained from another source, such as a cloud-based source of sequence of images 133, for instance. Deformation template 132/232 and each deformed velocity field 134/234 are provided as inputs to ML model-based corrector 140/240, which has been trained to predict deformations of velocity fields. ML model-based corrector 140/240 provides velocity field correction 136/236, which is combined with deformed velocity field 134/234, for example by summation or concatenation, to produce corrected velocity field 238. Density field 244 is produced by advection 242 of corrected velocity field 238, and may then be used by system 100 to produce corrected simulation 146 of the deformation of the fluid or viscoelastic material depicted in sequence of images 133.

By way of overview, the present solution for providing deformation-based fluid control utilizes differentiable simulation frameworks to enable gradient-based methods with the help of automatic differentiation. As a result, NNs or other ML models can be augmented for solving inverse problems more robustly. It is noted that although previous work in the art has focused on reducing numerical errors compared to given high-resolution reference samples, the present approach focuses on learning the reference manifold for the governing equations of motion for the material being deformed, directly, without samples for the rectification process of deformed flows. It is further noted that the present solution employs automatic differentiation to compute partial gradients in partial differential equations (PDEs) for training ML models such as NNs to solve simulations of material deformations in a self-supervised way.

As stated above although the present novel and inventive concepts are described below in detail by reference to deformation of fluids, those concepts may be readily adapted for application to a variety of viscoelastic materials. Nevertheless, the present concepts are described below by reference to a specific use case in which an incompressible fluid undergoes deformation. Consequently, the governing equations of motion for such an incompressible fluid are provided by the Navier-Stokes equations:

$$\frac{\partial u}{\partial t} + ( u \cdot ∇ ) u = - \frac{1}{ρ} ∇ p + μ {∇}^{2} u + f , \qquad ( Equation 1 )$$

$$∇ \cdot u = 0 , \qquad ( Equation 2 )$$

where u, p, and f denote the fluid velocity, pressure, and external force, respectively. External force can be represented through a force function f=f(ρ, u) that depends on the marker density and velocity fields. Viscosity terms may be omitted due to the inherent dissipation of velocity-pressure fractional stepping methods. A fluid solver for multiple time integrations of n from the time frame t is denoted as:

uₜ₊ₙ=Sⁿ(ρₜ, uₜ) (Equation 3)

with a step size of Δt. For simulating smoke, for example, the density field ρ may be passively advected ρₜ= [symbol] (ρ₀, U₀^{t-1}) where U₀^{t-1}={u₀, . . . , uₜ₋₁}_{(t≥1)} is the set of velocity fields computed from the solver.

Deformation-based fluid control can include two processes: a deformation D resulting in deformed velocity field 134, and a correction performed as a post-processing step by software code 110 of system 100, executed by hardware processor 104, and using ML model-based corrector 140/240 (C). The deformation process D may be performed independently of system 100, for example by user 128 utilizing client system 120 and deformation template 132 to deform original velocity field 230 of a fluid simulation. The deformation D is typically not restricted to any specific operations, and is often performed by manipulating an underlying 3D Cartesian grid of unit cubes to produce deformation grid or template 132/232.

For example, at time step t, a regular grid G may be deformed into another grid Ĝₜ through a displacement field Dₜ:Ĝₜ=G+Dₜ. To deform the simulation fields defined on regular grids σₜ(e.g., ρₜ, uₜ), the original velocity fields can be bi-linearly or tri-linearly sampled at the deformed grid Ĝₜ as the deformed fields \hat{σ}ₜ. This deformation process is denoted as \hat{σ}ₜ=D(σₜ, Ĝₜ).

Directly deforming the density fields ρₜ as described above can lead to visually unpleasant results because those fields can become overly stretched, compressed, or may otherwise deviate from what is physically plausible. Alternatively, the velocity fields uₜ themselves could be deformed over time and be used to passively advect density fields. However, such deformation of simulation velocity fields usually causes a breakdown of physical characteristics of the fields. For instance, when scaling the original simulation in one direction, e.g., along the x-axis, by 1.5 times, physical quantities (divergence, velocity magnitude, and the like) may be substantially affected and be caused to vary up to several times their original values. Moreover, directly deforming the velocity field can cause the velocity sequence to deviate significantly from the Navier-Stokes equations, or other governing equations of motion, as no specific constraints arising from those governing equations are typically applied to user inputs. These factors eventually lead to undesirable visual artifacts in the density fields advected by the deformed velocities.

The deformation-based fluid control solution disclosed in the present application uses ML model-based corrector 140/240 to correct the unphysical motions resulting from the direct deformation of original velocity field 230 resulting from use of deformation template 132/232. When implemented as an NN, the ML model-based corrector 140/240 can achieve faster inference at test time than conventional energy minimization approaches. When designing the objectives, the Navier-Stokes equations (Equations 1 and 2, above) are taken into consideration through the differentiable fluid solver at training time. Thus, applying ML model-based corrector 140/240 to deformed velocity field 134/234 based on deformation template 132/232 leads to corrected simulation 146 that better satisfies temporal advection of quantities and the divergence conditions of the underlying fluid motion.

ML model-based corrector 140/240 (C) takes deformed velocity field 134/234 (ûₜ) and deformation template 132/232 (Ĝₜ) as inputs, and outputs velocity field correction 136/236 (u′ₜ). To differentiate between simulations with distinct properties, ML model-based corrector 140/240 can optionally be conditioned on specific simulation parameters α (e.g., buoyancy, vorticity confinement scale). Velocity field correction 136/236 may be summed with or otherwise concatenated with deformed velocity field 134/234 to provide corrected velocity field 238 (ũₜ) given by:

ũₜ=ûₜ+u′ₜ, u′ₜ=C(ûₜ, Ĝₜ, α). (Equation 4)

Here the underlining of α indicates that it is an optional input. The correction is performed for all deformed velocity fields in a sequence of frames 133. The final density fields 244 (\tilde{ρ}ₜ) are obtained by t-recursive advections on the first deformed density frame with corrected velocity fields 238 as:

\tilde{ρ}ₜ= [symbol] (\hat{ρ}₀, Ũ₀^{t-1}) (Equation 5)

According to one exemplary implementation, ML model-based corrector 140/240 may take the form of a convolutional encoder-decoder. In one implementation, the encoder part downsamples the input field 4× for two-dimensional images (hereinafter “2D”), or 16× for 3D images, with residual blocks and strided convolutions. Deformation template 132/232 Ĝₜ may be restricted to a lower spatial resolution compared to the original velocities, since reducing the dimensionality of the deformations can help with generalization. Deformation template 132/232 is added as an input at the bottleneck of the network after going through a convolutional layer (subnet 241a). The optional simulation parameter a, when available, goes through another set of convolution layers (subnet 241b) before being input to ML model-based corrector 140/240 (C). Conditioning the architecture to varying simulation parameters α allows user 128 to have additional control over the appearance of corrected simulation 146. The decoder part upsamples the bottleneck features back to the original resolution with transposed convolutions.

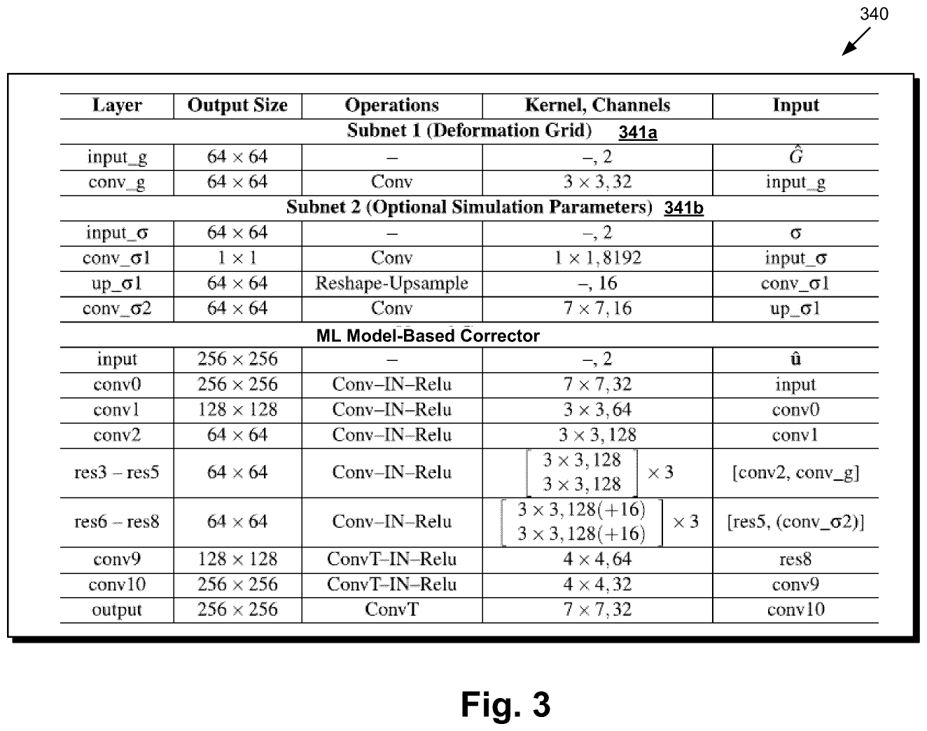

FIG. 3 describes an exemplary neural network architecture suitable for use as ML model-based corrector 340 for deformation-based fluid control, according to the exemplary implementation described above. It is noted that ML model-based corrector 340 including subnet 341a and subnet 341b corresponds in general to ML model-based corrector 140/240 in FIGS. 1 and 2. Consequently, ML model-based corrector 140/240 and subnets 241a and 241b may share any of the characteristics attributed to ML model-based corrector 340 including subnets 341a and 341b by the present disclosure, and vice versa.

Physics-informed loss functions are utilized to train ML model-based corrector 140/240/340 to predict deformations of velocity fields. In various implementations, at least one loss term of such a loss function is designed to impose constraints specified by the governing equations of motion of a particular fluid or viscoelastic material undergoing simulated deformation. It is noted that because user-input deformations can be arbitrary, it is very difficult to obtain reference corrected velocity fields. As a result, the loss functions utilized by the present approach are defined for training ML model-based corrector 140/240/340 in a self-supervised process.

In the exemplary use case in which incompressible fluids undergo simulated deformations, the governing equations of motion for the fluids are the Navier-Stokes equations identified above as Equations 1 and 2. A central feature of the objective functions utilized in the present deformation-based fluid control solution is implemented through a differentiable fluid solver for evaluating the ML model predicted velocity field deformation corrections. Under arbitrary user-input deformations, the original fluid simulations usually go off course to the outside of the Navier-Stokes manifold. The Navier-Stokes loss term ( [symbol] _{NS}) aims at projecting the velocity fields back onto the Navier-Stokes manifold. When advancing the corrected velocity field ũₜ by k solver steps, the resulted velocity field S^{k}(\hat{ρ}ₜ, ũₜ ) should be similar to the corrected velocity field at frame t+k:

[symbol]

_{NS}(Ũₜ^{t+n})=Σₖ₌₁ⁿ∥S^{k}(\hat{ρ}ₜ, ũₜ)−ũₜ₊ₖ∥₂². (Equation 6)

Here \hat{ρ}ₜ denotes the deformed velocity field density. By minimizing the Navier-Stokes loss, it is to be expected that the corrected velocities in the time sequence to not only connect themselves through self-advection and external force integration, but also satisfy boundary conditions through the pressure projection. It is noted that no ground-truth corrected velocity field sequence is required in the Navier-Stokes loss. Only a set of snapshots of deformed velocity fields is present in training. More solver steps will result in a better evaluation of the Navier-Stokes loss, but makes the loss computations more expensive. Exemplary values for n providing good trade-offs between quality and complexity have been found to be n=8 for 2D and n=4 for 3D.

In addition, the incompressibility constraint in Equation 2 is emphasized by minimizing the divergence of the corrected velocity fields for n rollout steps using divergence loss term ( [symbol] _{∇⋅}):

[symbol]

_{∇⋅}(Ũₜ^{t+n})=Σₖ₌₀ⁿ∥∇⋅ũₜ₊ₖ∥₂². (Equation 7)

Although the Navier-Stokes loss term implicitly takes the physical features of fluids into account, in some implementations it may be advantageous or desirable to consider certain physics characteristic losses. Examples of such additional loss terms may include kinetic energy loss ( [symbol] _{KE}), magnitude of vorticity loss ( [symbol] _{ω}), and gradient magnitude of density loss ( [symbol] _{∇ρ}). In those cases, the differences of the corrected physical fields compared to the original simulation fields are minimized according to:

[symbol]

_{KE}(Ũₜ^{t+n})=Σₖ₌₀ⁿ∥ũₜ₊ₖ−D(uₜ₊ₖ², Ĝₜ₊ₖ)∥₂, (Equation 8)

[symbol]

_{ω}(Ũₜ^{t+n})=Σₖ₌₀ⁿ∥|\tilde{ω}ₜ₊ₖ|−D(|ωₜ₊ₖ|, Ĝₜ₊ₖ)∥₂², (Equation 9)

[symbol]

_{∇ρ}(Ũₜ^{t+n})=Σₖ₌₀ⁿ∥|∇\tilde{ρ}ₜ^{t+k}|−D(|∇ρₜ₊ₖ|, Ĝₜ₊ₖ)∥₂². (Equation 10)

Here ωₜ₊ₖ=∇×uₜ₊ₖ is the vorticity field. \tilde{ρ}^{t+k}= [symbol] (\hat{ρ}ₜ, Ũₜ^{t+k-1}) is the corrected density, i.e. deformed density recursively advected by corrected velocity field sequence. When comparing the corrected and original simulation fields, each original field (e.g., ω in Equation 9) is deformed to the deformed space through D so that both fields can be compared at a same grid location. It is noted that deforming a physical quantity does not necessarily imply physical accuracy and these losses are used to preserve features of the original simulation. Similar to the Navier-Stokes loss [symbol] _{NS} and the divergence loss [symbol] _{∇⋅}, the kinetic energy loss [symbol] _{KE}, magnitude of vorticity loss [symbol] _{ω}, and gradient magnitude of density loss [symbol] _{∇ρ} are evaluated over n-rollouts.

The above losses push the corrected velocity field sequence into a physically-correct direction. However, only imposing the loss terms identified by Equations 6 through 10 above can potentially undo the user specified input deformations. Consequently, in some implementations it may be advantageous or desirable utilize a density guidance loss term ( [symbol] _{ρ}) to instruct ML model-based corrector 140/240/340 to follow the general look of the given deformed density fields according to:

[symbol]

₉₂ (Ũₜ^{t+n})=Σₖ₌₁ⁿ∥\tilde{ρ}^{t+k}−\hat{ρ}ₜ₋ₖ∥, (Equation 11)

Thus, according to some implementations, the full objective ( [symbol] ) for learning physics-informed corrections on deformed fluid flows may be defined as a weighted sum of the above-mentioned loss functions:

[symbol]

= [symbol] _{NS}+λ_{∇⋅} [symbol] _{∇⋅}+λ_{KE} [symbol] _{KE}+λ_{ω} [symbol] _{ω}+λ_{∇ρ} [symbol] _{∇ρ}+λ₉₂ [symbol] _{ρ} (Equation 12)

where λ-s are the weights for each loss term. With all loss terms combined together, the training helps the model find a better tradeoff where physical properties and user specified deformation signals are both satisfied better satisfied. In one exemplary fluid flow implementation, the following values for the λ-s were found to provide good results:

λ_{∇⋅}=10, λ_{KE}=0.1, λ_{ω}1, λ_{∇ρ}10, λ_{ρ}=10.

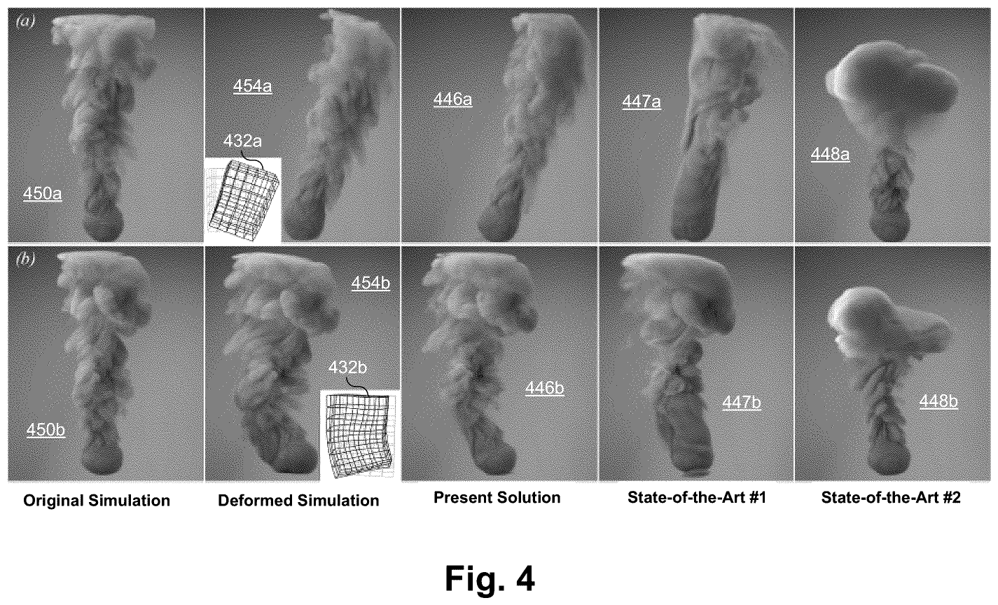

FIG. 4 compares fluid simulations produced using the present solution with two existing state-of-the-art approaches for different exemplary deformations of a rising smoke plume. Horizontal row of images (a) shows original (non-deformed) smoke plume simulation 450a undergoing deformation in the form of bending based on deformation grid 432a to provide deformed simulation 454a. Correction of deformed simulation 454a using the deformation-based fluid control solution disclosed by the present application results in simulation 446a. In contrast, correction of deformed simulation 454a using a first conventional state-of-the-art approach (disclosed by Sato S., Dobashi Y., Yue Y., Iwasaki K., Nishita T.: Incompressibility-preserving deformation for fluid flows using vector potentials. The Visual Computer 31, 6-8 (6 2015), 959-965. (hereinafter “SDY *15”)) results in simulation 447a, and correction of deformed simulation 454a using a second conventional state-of-the-art approach (disclosed by Pan Z., Manocha D.: Editing smoke animation using a deforming grid. Computational Visual Media 3, 4 (12 2017), 369-378. (hereinafter “PM17a”)) results in simulation 448a. It is noted that simulation 446a resulting from application of the present solution corrects the non-physical characteristics of deformed simulation 454a resulting from direct deformation of original smoke plume simulation 450a using deformation grid 432a. Examples of such non-physical characteristics include over stretching or compression of the fluid or viscoelastic material simulations, unwanted sources or sinks, simulations violating the governing equations of motion, or visual artefacts in the fluid or viscoelastic material simulation, to name a few.

Horizontal row of images (b) shows original (non-deformed) smoke plume simulation 450b undergoing deformation in the form of bending based on a different deformation grid 432b to provide deformed simulation 454b. Correction of deformed simulation 454b using the deformation-based fluid control solution disclosed by the present application results in corrected simulation 446b. In contrast, correction of deformed simulation 454b using SDY *15 results in simulation 447b, and correction of deformed simulation 454b using PM17a results in simulation 448b. Once again, simulation 446b resulting from application of the present solution corrects the non-physical characteristics of deformed simulation 454b resulting from direct deformation of original smoke plume simulation 450b using deformation grid 432b, as those non-physical characteristics are described above.

It is noted that corrected simulations 446a and 446b correspond in general to corrected simulation 146 output by system 100, in FIG. 1, while deformation grids 432a and 432b correspond in general to deformation template 132/232 in FIGS. 1 and 2. Consequently, corrected simulations 446a and 446b may share any of the characteristics attributed to corrected simulation 146 by the present disclosure, and deformation grids 432a and 432b may share any of the characteristics attributed to deformation template 132/232 by the present disclosure, and vice versa.

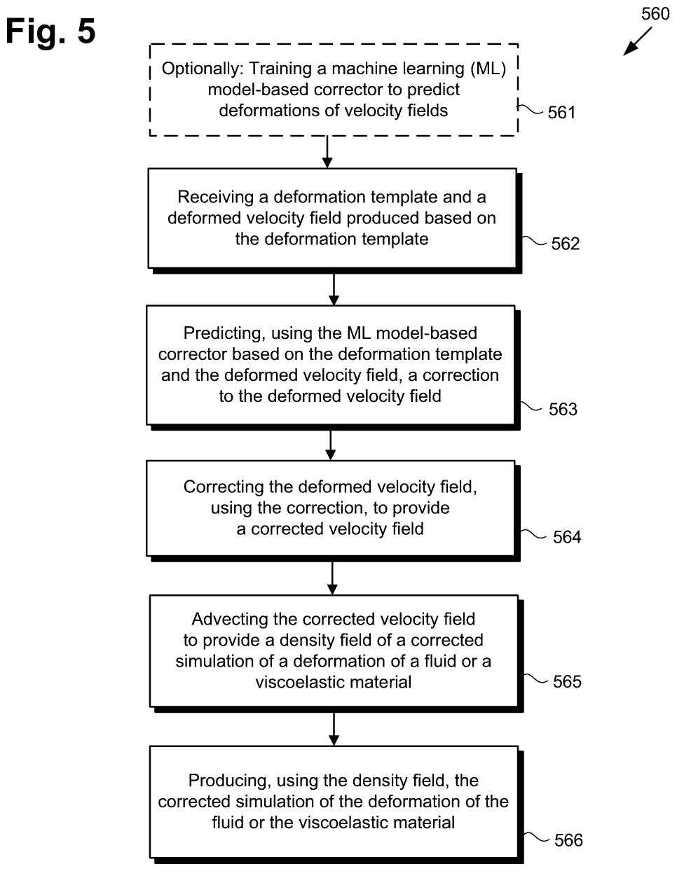

The functionality of system 100 including software code 110 and ML model-based corrector 140/240/340 will be further described by reference to FIG. 5, which shows flowchart 560 presenting a method for use by a system including a physics-informed ML model-based corrector for providing deformation-based fluid control, according to one exemplary implementation. With respect to the actions described in FIG. 5, it is noted that certain details and features have been left out of flowchart 560 in order not to obscure the discussion of the inventive features in the present application.

Referring to FIG. 5 in combination with FIGS. 1, 2, and 3, in some implementations the method outlined by flowchart 560 includes training ML model-based corrector 140/240/340 to predict deformations of velocity fields (action 561). It is noted that action 561 is optional, and in some use cases, ML model-based corrector 140/240/340 may be pre-trained to predict deformations of velocity fields. In implementations in which the method outlined by flowchart 560 includes action 561, ML model-based corrector 140/240/340 may be trained by software code 110 of system 100, executed by hardware processor 104.

As noted above ML model-based corrector 140/240/340 is trained using an objective function including a loss term specified by one or more governing equations of motion for the fluid or the viscoelastic material for which deformation is to be simulated. In use cases in which the fluid undergoing deformation is an incompressible fluid, the governing equations of motion for the fluid can be expressed as the Navier-Stokes equations shown above as Equations 1 and 2. It is noted that although the exemplary implementations referred to in detail in the present application are described by reference to incompressible fluids, the novel and inventive concepts disclosed herein may be readily adapted to compressible fluids and materials, such as viscoelastic materials for example. For the specific use case of incompressible fluids, a suitable objective loss based on the Navier-Stokes equations is described above by reference to Equation 6.

Moreover, in some implementations, the objective function used to train ML model-based corrector 140/240/340 may include a weighted combination of a plurality of loss terms including the loss term specified by the one or more governing equations of motion for the fluid or the viscoelastic material for which deformation is to be simulated, and at least one loss term derived from a physics-defined parameter of that fluid or viscoelastic material other than the one or more governing equations of motion. Once again referring to implementations in which the fluid undergoing deformation is an incompressible fluid, that/those loss terms may include one or more of a divergence loss, a kinetic energy loss, a vorticity loss, or a density gradient loss, as described, respectively, by Equations 7, 8, 9, and 10 above.

In addition, or alternatively, in some implementations the objective function used to train ML model-based corrector 140/240/340 may include a weighted combination of a plurality of loss terms including the loss term specified by the one or more governing equations of motion for the fluid or the viscoelastic material and at least one loss term based on a user-defined constraint. Yet again referring to implementations in which the fluid undergoing deformation is an incompressible fluid, such a user-defined constraint based loss term may take the form of the density guidance loss described above by reference to Equation 11.

Continuing to refer to FIG. 5 in combination with FIGS. 1 and 2, flowchart 560 includes receiving deformation template 132/232 and deformed velocity field 134/234 produced based on deformation template 132/232 (action 562). As noted above, deformed velocity field 134/234 corresponds to a respective deformed velocity field included in each of sequence of images 133. As further noted above, deformed velocity field 134/234 is derived from a simulation of deformation of a fluid or a viscoelastic material, as those features are defined above.

As shown in FIG. 1, in some implementations, deformation template 132 and deformed velocity field 134 included in sequence of images 133 may be received by system 100 from client system 120 via communication network 116 and network communication links 118. Deformation template 132 and deformed velocity field 134 included in sequence of images 133 may be received, in action 562, by software code 110 of system 100, executed by hardware processor 104.

Continuing to refer to FIG. 5 in combination with FIGS. 1 and 2, flowchart 560 further includes predicting, using ML model-based corrector 140/240 and based on deformation template 132/232 and deformed velocity field 134/234, velocity field correction 136/236 to deformed velocity field 134/234 (action 563). Action 563 may be performed by software code 110 of system 100, executed by hardware processor 104, as described above.

Continuing to refer to FIG. 5 in combination with FIGS. 1 and 2, flowchart 560 further includes correcting deformed velocity field 134/234, using velocity field correction 136/236, to provide corrected velocity field 238 (action 564). In some implementations, for example, deformed velocity field 134/234 and velocity field correction 136/236 may be summed or otherwise concatenated to provide corrected velocity field 238. Action 564 may be performed by software code 110 of system 100, executed by hardware processor 104, as described above.

In some implementations, the method outlined by flowchart 560 may conclude with action 564 described above. However, and continuing to refer to FIGS. 1, 2, and 5 in combination, in other implementations, flowchart 560 may further include advecting corrected velocity field 238 to provide density field 244 (action 565). In implementations in which the method outlined by flowchart 560 includes action 565, action 565 may be performed by software code 110 of system 100, executed by hardware processor 104, as described above.

Referring to FIGS. 1, 4, and 5 in combination, in some implementations flowchart 560 may further include producing, using density field 244, corrected simulation 146/446a/446b (action 566). In implementations in which the method outlined by flowchart 560 includes action 566, action 566 may be performed by software code 110 of system 100, executed by hardware processor 104. With respect to the actions included in flowchart 560, it is noted that in some implementations actions 562, 563, and 564 (hereinafter “actions 562-564”), or actions 562-564 and 565, or actions 562-564, 565, and 566, may be performed in an automated process from which human involvement may be omitted.

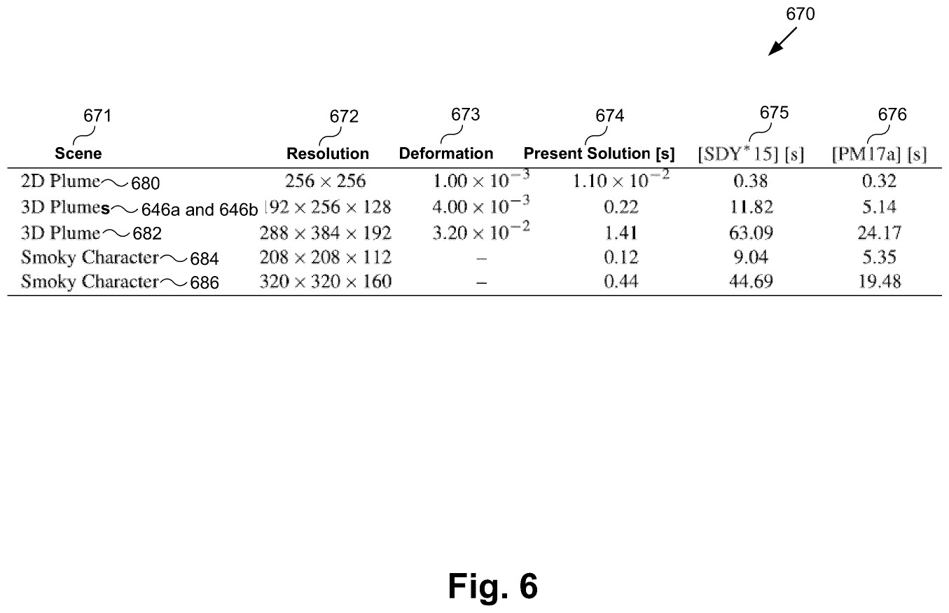

Referring to FIG. 6, FIG. 6 shows table 670 comparing fluid simulations produced using the present solution with the two state-of-the-art approaches, SDY *15 and PM17a, for different exemplary images depicting different fluid geometries, according to various implementations. Column 671 of table 670 identifies the scene, i.e., the sequence of frames, undergoing deformation, where those scenes variously depict deformations of 2D plume 680, 3D plumes 646a and 646b, higher resolution 3D plume 682, smoky character 684, and higher resolution smoky character 686. Column 672 identifies the resolution of each scene, and column 673 identifies the extent to which the scene is deformed, i.e., the time in seconds during which deformation template 230, in FIG. 2, is applied to original velocity field 230 to produce deformed velocity field 234. Columns 674, 675, and 676 show the respective runtime per frame required to produce a corrected deformation by the solution disclosed in the present application, as well as the runtime per frame required by each of state-of-the art methods SDY *15 and PM17a.

It is noted that the scene labeled 3D Plumes 646a and 646b corresponds to simulations 446a and 446b shown in and described by reference to FIG. 4 above. It is further noted that the method identified as SDY *15 is the same method used to produce simulations 447a and 447b, in FIG. 4, while the method identified as PM17a is the same method used to produce simulations 448a and 448b.

As shown by table 670, the present solution is able to provide a corrected simulation of the deformation of a scene at least an order of magnitude faster, and in most use cases, many orders of magnitude faster, than SDY *15 and PM17a. For example, referring specifically to the two 3D smoke plumes depicted in FIG. 4, identified as 3D Plumes 646a and 646b in FIG. 6, the present solution provides a corrected deformation frame in less than a quarter of a second, while PM17a requires more than five seconds and SDY *15 requires almost twelve seconds to produce corrected deformations. Thus, referring to FIG. 1, in contrast to state-of-the-art methods SDY *15 and PM17a, the present solution advantageously enables user 128 of client system 120 and system 100 to receive corrected simulation 146 at interactive frame rates, i.e., essentially in real-time, with respect to receiving deformed velocity field 134 and deformation template 132.

Thus, the present application presents a solution for providing deformation-based fluid control that addresses and overcomes the deficiencies in the conventional art. As noted above, the present solution seeks to balance the advantages of direct manipulation of fluids with the constraints imposed by their intrinsic physical characteristics. ML models, such as those implemented as NNs for example, may be trained with physics-informed loss functions together with a differentiable fluid simulator, thereby providing an efficient workflow for flow manipulations at test time. The results of applications of the present solution to diverse test cases demonstrate that the particularly designed objectives lead to physical and eventually visually appealing modifications on edited fluid data. The present solution advances the state-of-the-art by introducing a ML model-based corrector that projects an artistically deformed velocity field back onto the physical manifold defined by the governing equations of motion for a fluid or viscoelastic material at interactive frame rates, an objective function implemented through a differentiable fluid solver for evaluating the ML model-based corrections, and a set of physics-based loss functions used to train the ML model-based corrector in a self-supervised way.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor;
a machine learning (ML) model-based corrector trained to predict a deformation of a velocity field; and
a system memory storing a software code;
the hardware processor configured to execute the software code to:
receive a deformation template and a deformed velocity field produced based on the deformation template;
predict, using the ML model-based corrector and based on the deformation template and the deformed velocity field, a correction to the deformed velocity field; and
correct the deformed velocity field, using the correction, to provide a corrected velocity field.

2. The system of claim 1, wherein the deformed velocity field is derived from a simulation of a deformation of a fluid or a viscoelastic material.

3. The system of claim 2, wherein the hardware processor is further configured to execute the software code to:
advect the corrected velocity field to provide a density field of a corrected simulation of the deformation of the fluid or the viscoelastic material.

4. The system of claim 3, wherein the hardware processor is further configured to execute the software code to:
produce, using the density field, the corrected simulation of the deformation of the fluid or the viscoelastic material.

5. The system of claim 2, wherein the ML model-based corrector is trained using an objective function including a loss term specified by one or more governing equations of motion for the fluid or the viscoelastic material.

6. The system of claim 5, wherein the governing equations of motion are Navier-Stokes equations.

7. The system of claim 5, wherein the objective function comprises a weighted combination of a plurality of loss terms including (i) the loss term specified by the one or more governing equations of motion for the fluid or the viscoelastic material, and (ii) at least one loss term based on a user-defined constraint.

8. The system of claim 5, wherein the objective function comprises a weighted combination of a plurality of loss terms including (i) the loss term specified by the one or more governing equations of motion for the fluid or the viscoelastic material, and (ii) at least one loss term derived from a physics-defined parameter of the fluid or the viscoelastic material other than the one or more governing equations of motion.

9. The system of claim 8, wherein the at least one loss term derived from the physics-defined parameter of the fluid or the viscoelastic material other than the one or more governing equations of motion comprises one or more of a divergence loss, a kinetic energy loss, a vorticity loss, or a density gradient loss.

10. The system of claim 1, wherein the hardware processor is further configured to execute the software code to:
before receiving the deformation template and the deformed velocity field produced based on the deformation template, train the ML model-based corrector to predict deformations of velocity fields.

11. A method for use by a system including a hardware processor, a machine learning (ML) model-based corrector trained to predict a deformation of a velocity field, and a system memory storing a software code, the method comprising:
receiving, by the software code executed by the hardware processor, a deformation template and a deformed velocity field produced based on the deformation template;
predicting, by the software code executed by the hardware processor and using the ML model-based corrector, based on the deformation template and the deformed velocity field, a correction to the deformed velocity field; and
correcting the deformed velocity field, by the software code executed by the hardware processor and using the correction, to provide a corrected velocity field.

12. The method of claim 11, wherein the deformed velocity field is derived from a simulation of a deformation of a fluid or a viscoelastic material.

13. The method of claim 11, further comprising:
advect the corrected velocity field, by the software code executed by the hardware processor, to provide a density field of a corrected simulation of the deformation of the fluid or the viscoelastic material.

14. The method of claim 13, further comprising:
producing, by the software code executed by the hardware processor and using the density field, the corrected simulation of the deformation of the fluid or the viscoelastic material.

15. The method of claim 12, wherein the ML model-based corrector is trained using an objective function including a loss term specified by one or more governing equations of motion for the fluid or the viscoelastic material.

16. The method of claim 15, wherein the governing equations of motion are Navier-Stokes equations.

17. The method of claim 15, wherein the objective function comprises a weighted combination of a plurality of loss terms including the loss term specified by the one or more governing equations of motion for the fluid or the viscoelastic material and at least one loss term based on a user-defined constraint.

18. The method of claim 15, wherein the objective function comprises a weighted combination of a plurality of loss terms including the loss term specified by the one or more governing equations of motion for the fluid or the viscoelastic material and at least one loss term derived from a physics-defined parameter of the fluid or the viscoelastic material other than the one or more governing equations of motion.

19. The method of claim 18, wherein the at least one loss term derived from the physics-defined parameter of the fluid or the viscoelastic material other than the one or more governing equations of motion comprises one or more of a divergence loss, a kinetic energy loss, a vorticity loss, or a density gradient loss.

20. The method of claim 11, further comprising:
before receiving the deformation template and the deformed velocity field produced based on the deformation template, training the ML model-based corrector, by the software code executed by the hardware processor, to predict deformations of velocity fields.
